(19) United States
(12) Patent Application Publication
(10) Pub. No.: US 2006/0038357 A1
(43) Pub. Date: Feb. 23, 2006

(54) Wedging retainer gasket construction

(76) Inventor: Julian F. Kamibayashiyama, San Diego, CA (US)

Correspondence Address: John A. Molnar, Jr.;PARKER-HANNIFIN CORPORATION, 6035 Parkland Boulevard, Cleveland, OH, 44124-4141, US

(21) Appl. No.: 11/102,262

(22) Filed: Apr. 8, 2005

Related U.S. Application Data
(60) Provisional application No. 60/603,726, filed on Aug. 23, 2004.

(51) Int. Cl. F02F 11/00

(52) U.S. Cl. 277/594

(57) ABSTRACT

Sealing gasket construction for providing a fluid seal intermediate a pair of opposed, mating parts or structures, one of the parts having an edge and a void space defined along the edge. The gasket includes a retainer and a resilient seal element having a wedging portion extending radially beyond one of the retainer inner or outer perimeter. The wedging portion is configured in a free state to extend into the area of the void space and to be wedged against the other one of the interfacing parts, and thereby made to occupy at least a portion of the void space.

### CROSS REFERENCE TO RELATED CASES

The present application claims the benefit of the filing date of U.S. Provisional Application Ser. No. 60/603/726; filed Aug. 23, 2004, the disclosure of which is expressly incorporated herein by reference.

### BACKGROUND OF THE INVENTION

The present invention relates broadly to a sealing construction for providing a fluid seal intermediate a pair of opposed, mating parts or structures, and more particularly to such a construction including a wedge-shaped seal member which is adapted to fill a void volume created by a radiused edge of one of the mating parts so as to prevent fluid accumulation in such volume.

In basic construction, gaskets of the type herein involved are formed of one or more resilient sealing elements which are supported by sheet metal plate or other retainer which may be machined, stamped, molded or otherwise formed to conform to the geometry of the mating surfaces to be sealed. Particularly, the seal members may be molded-in-place or otherwise mounted in grooves formed into one or both sides of the retainer. Representative such gaskets are shown, for example, in U.S. Pat. Nos. 3,195,906; 3,215,442; 3,259,404; 3,578,346; 3,635,480; 3,720,420; 3,746,348; 4,026,565, 4,625,978, 5,890,719; 6,460,859; 6,553,664; 6,598,883; 6,69,537; and 6,669,205, in U.S. Pat. Appln. Pub. Nos. 2002/0135137A1 and US2002/0030326A1, and in co-pending U.S. Provisional Pat. Appln. Nos. 60/497,777, filed Aug. 26, 2003, and U.S. patent application Ser. No. 10/827,672, filed Apr. 19, 2004, and are marketed commercially by the Composite Sealing Systems Division of Parker-Hannifin Corporation, San Diego, Calif., under the tradenames “Gask-O-Seal” and “Integral Seal.”

Retainer gaskets of the type herein involved are employed in a variety of sealing applications, such as in commercial, industrial, or military equipment, vehicles, or aircraft for compression between the opposing or faying surfaces of a pair of mating parts or structures to provide a fluid-tight interface sealing thereof. In service, the gasket is clamped between the mating surfaces to effect the compression and deformation of the seal member and to develop a fluid-tight interface with each of those surfaces. The compressive force may be developed using a circumferentially spaced-apart arrangement of bolts or other fastening members, or by a threaded engagement of the mating parts.

Particularly in certain applications such as for ports, windows, access panels, or other openings in hulls, airframes, or other superstructures, there may be instances wherein liquids such as water may accumulate in spaces or other void volumes between the parts. Such accumulation may lead to corrosion and loss of service life. It therefore is believed that improvements in retainer gaskets such as for the above-mentioned applications would be well-received by the industries concerned.

### BROAD STATEMENT OF THE INVENTION

The present invention is directed to a retainer gasket construction particularly adapted for vertical mount and other applications such as for ports, windows, access panels, or other openings in hulls, airframes, or other superstructures. The gasket includes a generally-annular retainer and a wedge or similarly-shaped sealing element extending radially along at least a portion of one or both of the inner and/or the outer perimeter of the retainer.

When the gasket is placed between the interfacing surfaces to be sealed, with at least one of those surfaces having an edge confronting one of the sides of the gasket, the wedge-shaped sealing element thereof is positioned to extend into a void space defined along that edge. Such space may be formed, for example, by a radius or chamfer extending between the edge and the face of the corresponding one of the interfacing surfaces. In this regard, when the gasket thereupon is compressed between the interfacing surfaces, the wedge shape of the sealing element assists in filling with seal material the void space that otherwise would be formed at the radiused edged of the one of the surfaces. In so filling such space, the gasket of the present invention advantageously eliminates an area in which fluid otherwise could collect. Such collection can result in increased potential for corrosion and a loss of service life.

The present invention, accordingly, comprises the article possessing the construction, combination of elements, and arrangement of parts which are exemplified in the detailed disclosure to follow. Advantages of the present invention include a gasket construction which reduces the potential for corrosion of the interfacing surface being sealed. Additional advantages include a gasket construction which is economical to manufacture, and which may be adapted for use with various sealing configurations. These and other advantages will be readily apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a plan view of a representative embodiment of a gasket construction according to the present invention;

FIG. 2 is an enlarged, fragmentary cross-sectional view of the gasket of FIG. 1 taken through line 2-2 of FIG. 1;

FIG. 3 is a perspective view of one of the mating surfaces in a representative application for the gasket of FIG. 1;

FIG. 4 is an enlarged perspective view showing the edge detail of the mating surface of FIG. 3;

FIG. 5A is a fragmentary, cross-sectional, somewhat schematized and exploded assembly view showing the gasket of FIG. 1 as interposed between the mating surface of FIG. 3 and an associated mating surface; and

FIG. 5B is a view as in FIG. 5A in showing the gasket of FIG. 1 as compressed within the assembly of FIG. 5A.

The drawings will be described further in connection with the following Detailed Description of the Invention.

### DETAILED DESCRIPTION OF THE INVENTION

Certain terminology may be employed in the following description for convenience rather than for any limiting purpose. For example, the terms “forward” and “rearward,” “front” and “rear,” “right” and “left,” “upper” and “lower,” “top” and “bottom,” and “right” and “left” designate directions in the drawings to which reference is made, with the terms “inward,” “inner,” “interior,” “inside,” or “inboard” and “outward,” “outer,” “exterior,” “outside,” or “outboard” referring, respectively, to directions toward and away from the center of the referenced element, the terms “radial” or “vertical” and “axial” or “horizontal” referring, respectively, to directions, axes, or planes perpendicular and parallel to the longitudinal central axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows or underscores.

For the illustrative purposes of the discourse to follow, the precepts of the retainer gasket construction of the present invention are described in connection with the configuration thereof for use within a port, window, access panel, or other opening assembly such as within a hulls, airframe, or other superstructures. In view of the discourse to follow, however, it will be appreciated that aspects of the present invention may find utility in other fluid sealing applications requiring a gasket of the type herein involved. Use within those such other applications therefore should be considered to be expressly within the scope of the present invention.

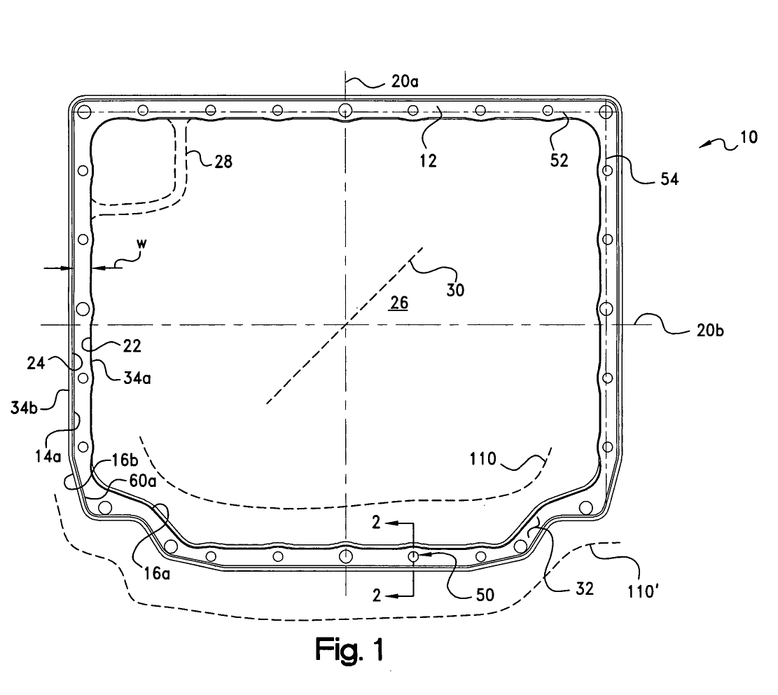

Referring then to the figures wherein corresponding reference characters are used to designate corresponding elements throughout the several views with equivalent elements being referenced with prime or sequential alphanumeric designations, shown generally at 10 in the plan view of FIG. 1, with the reverse side in the illustrated embodiment being understood to be substantially the same as the side shown, is a representative embodiment according to the present invention of a wedging-effect retainer gasket construction configured for interposition between a mating pair of mutually-opposed interfacing surfaces. In basic construction, gasket 10 includes a generally annular and, typically, planar retainer, 12, and one or more pairs of generally annular seal elements, 14a-b (with element 14b being on the reverse of the side of the gasket 10 depicted in FIG. 1) and 16a-b, which may be supported, such as with elements 14a-b, on a corresponding side of the retainer, or as extending, such as with elements 16a-b, from and along at least a portion of a corresponding perimeter of the retainer 12, to be compressible intermediate the interfacing surfaces (not shown in FIG. 1) for effecting a fluid-tight or other environmental and/or electromagnetic interference (EMI) seal therebetween.

Retainer 12 may be configured and sized as shown for interposition between the interfacing surfaces, such as about a port, window, or other opening in a hull, airframe, or other superstructure, and an associated cover for such opening. In this regard, retainer 12 may extend in the radial directions defined by the orthogonal horizontal or radial axes referenced at 20a-b in FIG. 1 as having an inner perimeter or margin, referenced at 22, and an outer perimeter or margin, referenced at 24. The perimeters 22 and 24 generally define, respectively, the inner and outer diametric extents of the retainer 12 which generally may be sized such that the gasket 10 is receivable intermediate the interfacing surfaces to be sealed. Together, the inner and outer perimeters 22 and 24 define a closed geometric shape which, in turn, encloses an opening, 26, which may be configured for registration with the opening in the assembly to be sealed. Although the shape of retainer 12 is shown for purposes of illustration to be generally rectangular, such shape alternatively may be square or otherwise regular or irregular polygonal, or otherwise curvilinear, or circular, elliptical, otherwise arcuate or curvilinear, as particularly may depend upon the specifics of the intended application. Retainer 12 also may be provided to have one or more dividers, such as referenced in phantom at 28, or other partitions formed therein, and may even have an open, i.e., linear or rectilinear, geometry rather then closed geometry shown.

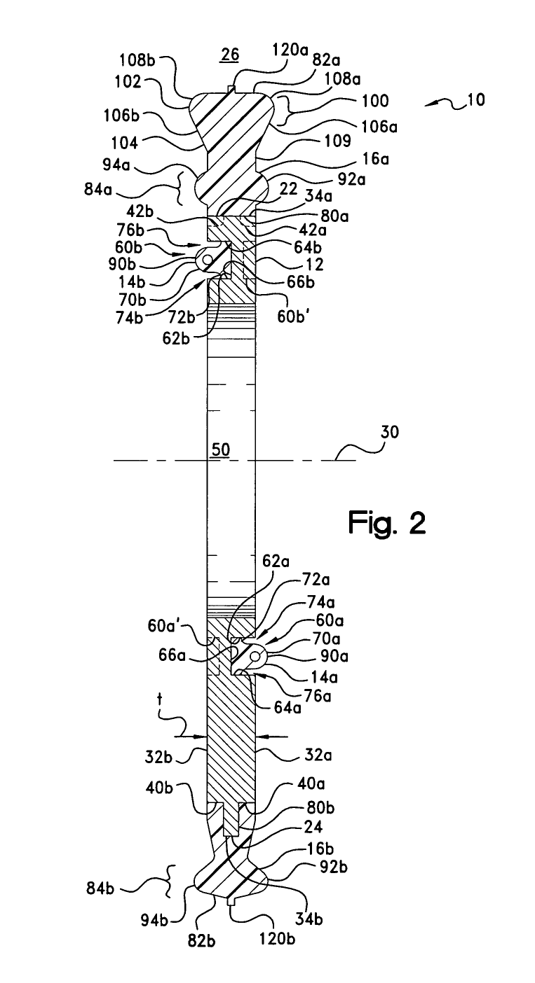

With additional and, for the moment, particular reference to cross-sectional view of FIG. 2, retainer 12 further may be seen to be formed relative to a central or vertical axis, referenced at 30, which axis extends in an axial direction generally normal to the radial direction referenced by axes 20 of FIG. 1, as having mutually-opposing upper and lower radial sides or faces, 32a-b, respectively, extending between the inner and outer perimeters 22 and 24, and mutually-opposing inner and outer axial sides or faces, 34a-b, respectively, each of which delineates a corresponding one of the perimeters 22 and 24 in extending between the radial faces 32a-b. Radial faces 32 each may be generally planar within the plane of the axes 20, but alternatively may exhibit one or more degrees of curvature or other deviations out of that plane to match the curvature of the corresponding interfacing surfaces to be sealed. Axial surfaces 34 similarly may be generally planar within the plane of axis 30 and one of the axes 20a-b as the case may be, but alternatively may be angled relative to axis 30.

Optionally, retainer 12 may be alternatively configured for the attachment of a corresponding one of the seal elements 16a-b thereto as having a continuous or discontinuous undercut or rabbet, referenced in FIG. 2 at 40a-b and in phantom at 42a-b, formed about one or both of the axial faces 34 in or on one or both of the radial faces 32. Although not required, such rabbets 40 and 42 may be provided to function as flash control channels and additionally to provide an increased bondline surface for the attachment and support of the seal elements 16 on the retainer 12.

Returning to the plan view of FIG. 1, the inner and outer perimeters 22 and 24 of retainer 12 define a widthwise extent, referenced at “w”, of the retainer therebetween which is sized such that gasket is receivable intermediate the interfacing surfaces to be sealed. Depending upon the specifics of the application, retainer 12 additionally may be provided as including a plurality of throughbores or apertures, one of which is referenced at 50 for the location and alignment of the gasket 10 between the interfacing surfaces. Each of the apertures 50 may be formed into the retainer 12 to extend axially through the upper and lower radial faces 32a-b thereof intermediate the inner and outer perimeters 22 and 24. The apertures 50 particularly may be spaced-apart along the retainer as disposed along a predefined bolt path, such as is shown at 52 and 54, and may be employed for receiving the bolts or other fasteners which are conventionally used for joining the interfacing surfaces under a predetermined torque load. Advantageously, apertures 50 in conjunction with retainer 12 additionally provide a positive stop delimiting the compression of the gasket 10 in avoiding the over-compression thereof during installation or maintenance.

Retainer 12 itself may be fabricated from a rigid or flexible metal, plastic, ceramic, or other material or composite which may be machined, cast, molded, stamped, or otherwise fabricated. Suitable metal materials for the construction of retainer 12 include aluminum, steel, stainless steel, copper, brass, titanium, nickel, and alloys thereof, with aluminum being preferred for many applications. The metal may be anodized, plated, or otherwise for increased corrosion resistance. Depending upon its material of construction and the intended application, retainer 12 may have an axial thickness, referenced at “t” in FIG. 2, defined between radial faces 32a-b of between about 0.025-1 inch (0.0635-2.5 cm), thereby making the retainer generally rigid or flexible, as the case may be, within the joint to be assembled.

As is shown in the views of FIGS. 1 and 2, retainer 12 further may be formed, against as depending upon the specific requirements of the intended application, as having a pair of grooves, 60a-b (with groove 60b being on the reverse of the side of the gasket 10 depicted in FIG. 1), for the mounting of the elements 14a-b. Each of the grooves 60 may be machined or otherwise recessed into a corresponding one of the radial faces 32 of retainer 12 intermediate the inner and outer perimeters 22 and 24 thereof, and as extending substantially continuous along the closed geometry of the retainer 12 about the opening 26. As may be seen best in FIG. 2, each of the grooves 60a-b may be configured as a generally U-shaped channel including an axial inner sidewall, 62a-b, adjacent the inner perimeter 22, and an opposing axial outer sidewall, 64a-b, adjacent the outer perimeter 24 which is disposed a spaced-apart radial distance from the corresponding inner sidewall 62. A radial bottom wall, 66a-b, extends intermediate a corresponding pair of the inner and outer sidewalls 62 and 64.

With retainer 12 being provided as has been described, in the further construction of the gasket 10, each of the seal elements 14a-b may be adhesively bonded, interference fit, molded, or otherwise received within a corresponding one of the retainer grooves 60. In the case of the seal elements 16a-b, each of these elements, in turn, may be adhesively bonded, molded on, or otherwise attached to or otherwise supported about a face 34 of a corresponding retainer perimeter 22 or 24. Each of the elements 14 and 16 may be provided, independently and as shown, as continuous or, alternatively, discontinuous, i.e., segmented or otherwise interrupted, single, double, or multiple beads, lobes, or other rings of one or more elastomeric materials.

As may be seen best in FIG. 2, each of the seal elements 14a-b may be formed with a corresponding groove 60a-b as a solid or, as shown, hollow bead, 70a-b, and as additionally having a base portion, 72a-b, each of which supports a corresponding one of the beads 70a-b on an bottom wall 66a-b of the corresponding groove 60a-b. Although a single element 14 is shown to be provided on each face 32 on opposite lateral sides of the holes 50, such as for the purpose of providing EMI sealing, it should be appreciated that each of the grooves 60a-b may have a corresponding groove, such as shown in phantom at 60a′-b′, for receiving additional seal elements 14 (not shown). As provided, each of the beads 70 is contactable by one of the mating interface surfaces for the axial sealing compression of the seal elements 14 within the intended application. In this regard, each of the beads 70 may be spaced apart from the groove sidewalls 62 and 64 or, alternatively, oriented to one or the other side so as to define one or more annular gaps, 74a-b and 76a-b, with the sidewalls to accommodate the deformation of the beads 70 when compressed such that the surfaces thereof each may lie coplanarly with a corresponding one of the retainer surfaces 32 when the seal elements 14 are energized between the interface surfaces.

Each of the seal elements 16, in turn, may extend radially from the retainer 12 and generally coplanarly therewith, and may be formed as having, respectively, an inboard side, 80a-b, and an opposing outboard side, 82a-b, which defines the corresponding inner or outer sealing periphery of the gasket 10. Particularly, the inboard side 80a of the seal element 16a is attached to the inner perimeter 22 of the retainer 12 such that the outboard side 82a of the element 16a thereby defines the inner periphery of the gasket 10 in extending, preferably, generally continuously about the retainer inner perimeter 22. Similarly, the inboard side 80b of the seal element 16b is attached to the outer perimeter 24 of the retainer 12 such that the outboard side 82b of the element 16b defines the outer periphery of the gasket 10 in extending, preferably, generally continuously about the retainer outer perimeter 24.

For the axial, sealing compression of the seal elements 16 between the mating interface surfaces within the intended application, each of the elements 16a-b may be configured, as may be seen best in FIG. 2, as having at least one bead or bead portion, referenced at 84a-b, respectively, for effecting the sealing of the interfacing surfaces. Depending upon the geometry of those surfaces, the beads or bead portions 84, as well as beads 70a-b of elements 14a-b, may be provided to extend axially beyond the corresponding radial faces 32 of the retainer 12 for abutting, compressive contact with a corresponding one of the interfacing surface. That is, bead portions 70 and 84 may be provided, as is shown in FIG. 2, to protrude between about 1-100 mils (0.025-2.5 mm) beyond the corresponding radial face 32. Beads 84 may be shaped, as is shown, to have a generally circular or elliptical cross-sectional geometry, but alternatively may be configured as being lobe or otherwise arcuate-shaped. Double or other multiple bead arrangements also may be provided.

In the described configuration, each of the beads 70 and 84 presents, in the case of beads 70, a generally hemispherical bearing surface, 90a-b, respectively, and, in the case of the beads 84, oppositely disposed, generally hemispherical upper, 92a-b, and lower, 94a-b, bearing surfaces which together with the surfaces 90 define the upper and lower sealing surfaces of the gasket 10. Each of the seal elements 14 and 16 is shown in the illustrative embodiment 10 of FIG. 1 to extend about the peripheries of retainer 12 for generally coaxial registration with the margins of the interface faces of the application, although it will be appreciated that different and/or independent geometries of gasket 10 and the seal element 14 and 16 thereon may be envisioned depending upon the configuration of the corresponding interface surfaces of the intended application, and indeed, the elements 14 and 16 may be interchanged.

In accordance with the precepts of the present invention, seal element 16a further may be configured additionally as having an wedging portion, referenced at 100, disposed outboard of the bead portion 84a to extend radially along at least a segment or other continuous or discontinuous portion of the length thereof. As may be seen best in the cross-sectional view of FIG. 2, wedging portion 100 may be formed integrally with the bead portion 84a in the seal element 16a. Wedging portion 100 may be generally wedge-shape in having a axially thicker outboard side, 102, which tapers radially inwardly to an axially thinner inboard side, 104, which may be disposed adjacent the bead portion 84a. The thicker outboard side 102 functions as a wedge in the manner which is to be described, and thereby itself presents in the illustrated embodiment of gasket 10 oppositely disposed, radially inwardly angled upper and lower tapered surfaces, 106a-b, respectively, each of which may extend radially outwardly to upper and lower bearing surfaces, 108a-b, which may extend axially beyond the extent of a corresponding one of the bearing surfaces 92a and 94a of bead portion 84a. The tapered surfaces 106a-b also may extend radially inwardly to connect with the seal element 16b via a transitional portion, 109.

Although wedging portion 100 is shown to be double-sided and generally symmetrical, it should be appreciated that single-sided and/or asymmetrical designs may be envisioned, e.g., with one of the bearing surfaces 108a-b being smaller than the other or with one extending conterminously with the bead portion 84a or as being generally flat, and therefore should be considered to be within the scope of the invention herein involved. Moreover, although wedging portion 100 is shown in FIG. 1 to extend generally continuously along the segment of the seal element 16a delineated by the line 110, it may be appreciated that portion 100 may be discontinuous, i.e., broken, interrupted or stepwise, along the segment 110. Addition or other continuous or discontinuous segments of the portion 100 also may be provided. Alternatively, portion 100 may be provided to extend continuously or discontinuously along the entirety or substantially the entirety of the element 16a. Likewise, a portion 100 also may be provided, as represented by the line designated 110′, as formed integrally with the bead portion 84b of element 16b in addition to or as an alternative to the portion 100 formed in the element 16a.

In the manufacture of gasket 10, with the retainer 12 being formed, for example, as a metal stamping, molding, or machine part, with grooves 60 being stamped, molded, or machined therein the corresponding radial faces 32, such grooves, along with the axial faces 34 of the retainer 12 may be primed with a bonding agent, such as a siloxane or silane, to assist in the chemical bonding of the seal elements 14 and 16 thereto. The primed retainer 12 then may be placed into a heated molded cavity for the injection, compression, or transfer molding of an uncured rubber or other elastomeric compound forming the seal elements 14 and 16. Each of the elastomeric seal elements 14 and 16 thereby may be formed and cured-in-place as vulcanized directly onto retainer 12. The outboard mold flash, referenced at 120a-b, as may be seen in the cross-sectional view of FIG. 2, need not be removed as having no effect on the sealing performance of the gasket 10. Alternatively, one or more of the elastomeric seal elements 14 and 16 may be molded in a separate operation and bonded to retainer 12 using an adhesive, an interference fit, a mechanical attachment, or the like.

Each of the seal elements 14 and 16 may be formed, independently, of a rubber or other elastomeric material which may be selected specifically for high temperature performance or otherwise for compatibility with the fluid being handled. Suitable materials include natural rubbers such as Hevea, as well as thermoplastic, i.e., melt-processible, or thermosetting, i.e., vulcanizable, synthetic rubbers such as fluoropolymers, chlorosulfonate, polybutadiene, polybutadiene, buna-N, butyl, neoprene, nitrile, polyisoprene, silicone, fluorosilicone, copolymer rubbers such as ethylene-propylene (EPR), ethylene-propylene-diene monomer (EPDM), nitrile-butadiene (NBR) and styrene-butadiene (SBR), or blends such as ethylene or propylene-EPDM, EPR, or NBR. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

Fillers and additives may be included in the formulation of the seal elements depending upon the requirements of the particular application envisioned. Such fillers and additives may include conventional wetting agents or surfactants, pigments, dyes, and other colorants, dispersants, opacifying agents, anti-foaming agents, antioxidants, anti-static agents, coupling agents such as titanates, chain extending oils, tackifiers, pigments, lubricants such as molybdenum disulfide (MoS₂), stabilizers, emulsifiers, antioxidants, inerts, thickeners, and/or flame retardants such as aluminum trihydrate, antimony trioxide, metal oxides and salts, intercalated graphite particles, phosphate esters, decabromodiphenyl oxide, borates, phosphates, halogenated compounds, glass, silica, which may be fumed or crystalline, silicates, mica, and glass or polymeric microspheres, as well as fillers which are thermally- and/or electrically-conductive such as oxides, nitrides, carbides, diborides, graphite, and metal particles, and mixtures thereof. Other electrically-conductive fillers include metal flakes and fibers, as well as conductive or non-conductive particles, plates, fibers, hollow or solid microspheres, elastomeric balloons, or other particulates plated or otherwise coated with a metal. The particle size of such fillers typically is not considered critical, and may be or a narrow or broad distribution or range, but in general may be between about 0.250-250 μm. Such fillers and additives may be blended or otherwise admixed with the formulation, and may comprise between about 0.05-80% or more by total volume thereof. The formulation may be compounded in a conventional mixing apparatus.

For EMI shielding purposes, the electrically-conductive filler may loaded in the composition in a proportion sufficient to provide the level of electrical conductivity and EMI shielding effectiveness within the gap which is desired for the intended application. In this regard, an EMI shielding effectiveness of at least 10 dB, and usually at least 20 dB, and preferably at least about 60 dB or higher, over a frequency range of from about 10 MHz to 10 GHz is considered acceptable. Such effectiveness translates to a filler proportion which generally is between about 10-80% by volume or 50-90% by weight, based on the total volume or weight, as the case may be, of the compound, and a bulk or volume resistivity of not greater than about 1 Ω-cm, although it is known that comparable EMI shielding effectiveness may be achieved at lower conductivity levels through the use of an EMI absorptive or “lossy” filler such as a ferrite or nickel-coated graphite. As is also known, the ultimate shielding effectiveness of the seal elements 14, if provided for EMI shielding, may vary based on the amount of the electrically-conductive or other filler material, and on the thickness thereof.

Advantageously, seal elements 14 and 16 exhibit a reduced yield stress as compared to retainer 12 and, accordingly, are deformable for conforming to irregularities existing between the interfacing surfaces. As will be more fully appreciated hereinafter, as given compressive load is applied to the seal elements 14 and 16, an increased bearing stress is provided thereon by virtue of the reduced surface area contact of the bearing surfaces of the bead portions 90, 92, 94, and 106 on the interfacing surfaces. This increased stress will be sufficient to exceed the reduced yield stress of the seal elements 14 and 16 for the deformation thereof effecting the fluid-tight, EMI, and/or other sealing of the interfacing surfaces.

In service, it has been observed that the provision of seal elements 14 and 16 advantageously facilitates the installation and replacement of gasket 10 in accommodating for tolerances or other minor differences in the torque load of the bolts or other fastening members conventionally employed to join the interfacing surfaces. That is, by virtue of the resiliency of the elastomeric seal elements 14 and 16, the fluid integrity and other sealing of the gasket 10 may be maintained to some degree even if the joint spacing between the interfacing surface is less than exactly uniform. Moreover, the combination of a relatively incompressible retainer 12 and relatively compressible seal elements 14 further provides a gasket construction which minimizes torque loss and thereby obviates much of the need for the periodic re-torquing of the fastening members used to secure the interfacing surfaces. That is, it is well-known that gaskets of the type herein involved may develop a compression set which is manifested by fluid leaks as the tension in the bolts is relaxed and the fluid-tight sealing of the interfacing surfaces is compromised. In this regard, the provision of seal elements 14 and 16 ensures positive sealing, with retainer 12, in turn, synergistically providing generally non-yielding contact in establishing an alternative load torque path minimizing the compression set and leak potential of the gasket 10. Thus, the use of a retainer allows the mating parts to bear stress loads which otherwise would cause the deformation or extrusion of a gasket which lacked a retainer. In the case of a metal retainer 12, such contact additionally affords improved heat transfer between the interface surfaces, and also develops relatively high seal stresses for assured fluid-tight sealing of the interfacing structures.

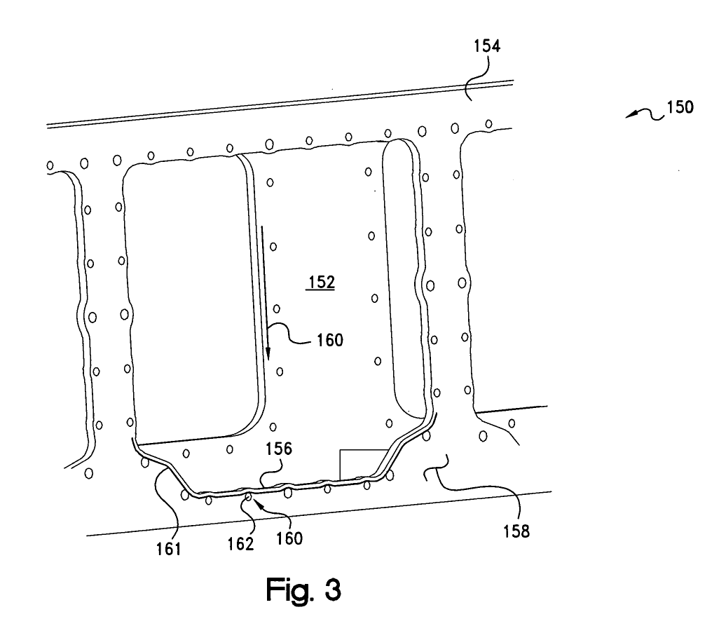

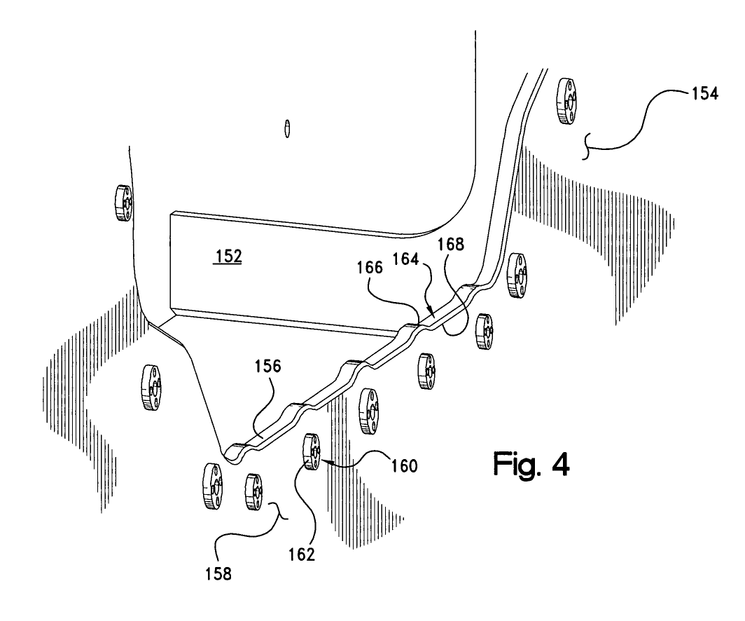

Referring now to the perspective view of FIG. 3 and the detail view of FIG. 4, a representative application for gasket 10 of the present invention is shown generally at 150 as an opening, 152, in a generally vertically-orientated portion, 154, of a hull or other superstructure, which opening 152 is surrounded at an edge, 156, by one the interfacing surfaces, 158, of the assembly for the gasket 10. A series of bolt, rivet, or other fastener holes, one of which is referenced at 160, each of which has an associated boss, 162, is formed in the surface 158 as surround the opening 152. Although the edge 156 is shown in the views of FIGS. 3 and 4 to surround an opening, it should be appreciated that such edge alternatively may surround a groove or the like. Such edge 156 also may be the inner or outer periphery of surface 158 itself.

As indicated by the arrow referenced at 160 in FIG. 3, water and other fluids to which the hull portion 154 may be exposed may settle down by gravity into the area designated at 161. As may be seen best in the enlarged view of such area of FIG. 4, the fluid particularly may collect in a void volume or other space, referenced at 164, along the edge 156. In the illustrative application 150 of FIGS. 3 and 4, the void space 150 may be defined along the edge 156 by a radius or chamfer, 166, extending between the radial terminus, referenced at 168, of the surface 158 and the edge 156.

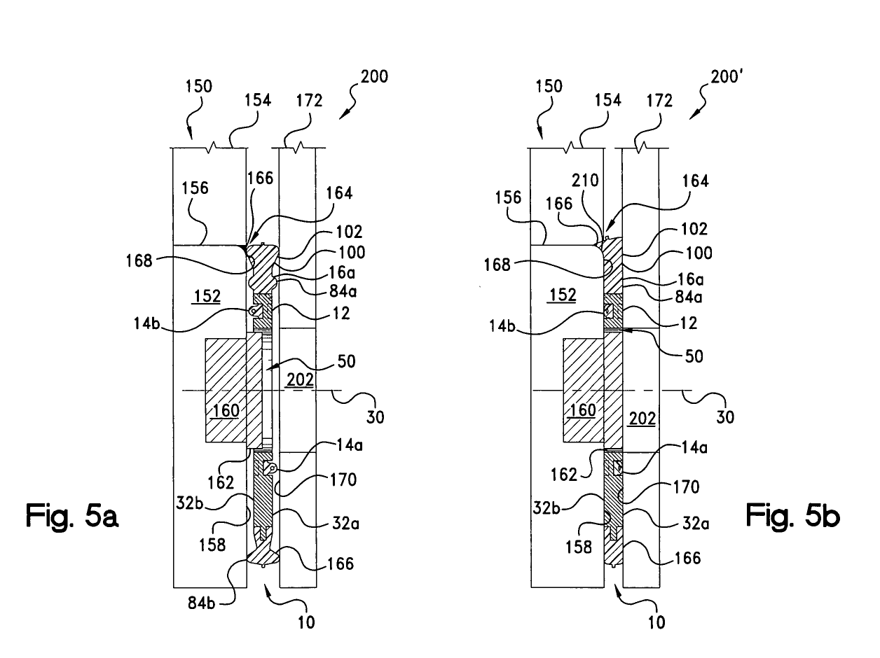

Turning now to the exploded assembly view of FIG. 5A, a representative joint assembly incorporating gasket 10 of the present invention and hull portion 154 of FIG. 3 is shown generally at 200. Within joint assembly 200, gasket 10 of the present invention is interposed between a pair of mutually-facing, axially spaced-apart interfaces surfaces. One of such surfaces is the surface 158 of the hull portion 154, and the other of such surfaces, referenced at 170, may be on an associated cover or other panel, 172, for the opening 152. The surface 170 may have holes or other openings, one of which is referenced at 202, for registration with the holes 160 of surface 170.

As interposed therebetween surfaces 158 and 170, the opening 26 of the gasket 10 may be aligned in registration with the hull opening 152, with the gasket 10 otherwise being disposed coaxially about the opening 152 with each of the retainer apertures 50 being aligned in registration intermediate a corresponding pair of holes 160 and 202. In this regard, each of the apertures 50 may be sized to receive therein a corresponding one of the bosses 162 of the holes 160. As further may be seen in FIG. 5A, the bead portion 84a of seal element 16a is disposed radially inwardly of the terminus 168 of edge 156 of surface 158 for compression therebetween and surface 170, but with at least the outboard side 102 of wedging portion 100 being disposed to extend radially past, i.e., outwardly, of the terminus 168 of the confronting surface 158 and at least partially into the area of the void space 164 along the edge 156.

Turning now to FIG. 5B, as the interfacing surfaces 158 and 170 are displaced in the assembly 200, now referenced as 200′, such as by the tightening of bolts or other fasteners (not shown) received through the aligned holes 50, 160, and 202, into abutting contact with the corresponding radial faces 32 of gasket 10, it may be seen that seal elements 14a-b and 16b each are contacted by a corresponding interfacing surface 158 and/or 170, and are compressed therebetween and, in the case of elements 14a-b, a corresponding groove bottom wall 66a-b, from the free state shown in FIG. 5A into the energized state shown in FIG. 5B. Such energized state effects, for example, an EMI seal in the case of elements 14 and a generally fluid-tight seal in the case of element 16b between each of the interfacing 158 and 170 and the retainer 12 of the gasket 10.

In the energized state of FIG. 4B, it further may be seen that the wedging portion 100 of seal element 16a is wedged by or against the surface 170. Such wedging action causes at least the outboard side 102 of the wedging portion 100 extending beyond the radial terminus 168 of surface 158 to be deflected into or otherwise made to fill and occupy at least a portion of the space 164 which otherwise would be defined, such as is represented at 210, by the radius or chamfer 166 and a confronting surface such as the end portion of the seal element 16b or alternatively, the other interfacing surface 170. However, by the occupation of the space 164 by the wedging portion 100, the accumulation of fluid in the space 164 may be excluded or at least reduced, with a corresponding reduction in the potential for corrosion to develop in such space.

Thus, a unique gasket construction for commercial, industrial, military, or other applications is described which exhibits reliable sealing properties while providing for the exclusion of fluid accumulation between the interfacing surfaces.

As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

What is claimed is:

1. A gasket for interposition between a first and a second interfacing surface, one of the interfacing surfaces having an edge and a void space defined therealong, the gasket comprising:
a retainer having an inner perimeter and an outer perimeter, and having opposing first and second radial faces each extending in a radial direction intermediate the inner and outer perimeter; and
a generally annular first seal element supported on the retainer to extend radially beyond one of the retainer inner or outer perimeter, the first seal element having an inboard sealing portion extending along at least a portion of the one of the retainer inner or outer perimeter and an outboard wedging portion extending along at least a portion of the sealing portion and having an inboard side disposed adjacent the sealing portion and an outboard side, the sealing portion being configured in a free state to be compressible in an axial direction generally normal to the radial direction intermediate the interfacing surfaces into an energized state effecting a seal therebetween, and the outboard side of the wedging portion being configured in a free state to extend into the area of the void space along the edge of the one of the interfacing surface and to be wedged against the other one of the interfacing surfaces and thereby made to occupy at least a portion of the void space.

2. The gasket of claim 1 wherein the void space is defined by a radius or chamfer of the one of the interfacing surfaces, the radius or chamfer extending between a radial terminus of the one of the surfaces and the edge, the outboard side of the wedging portion being configured in a free state to extend beyond the radial terminus of the one of the surfaces.

3. The gasket of claim 1 wherein:
the retainer inner and outer perimeter define a closed geometry; and
the first seal element extends radially beyond the retainer inner perimeter and defines an inner periphery of the gasket.

4. The gasket of claim 1 wherein the first seal element extends generally continuously along substantially the entirety of the one of the retainer inner or outer perimeters.

5. The gasket of claim 1 wherein the retainer has an inner axial surface extending axially intermediate the first and second radial faces which inner axial surface defines the inner perimeter of the retainer, and an outer axial surface extending intermediate the first and second radial faces which outer axial surface defines the outer perimeter of the retainer.

6. The gasket of claim 1 wherein the sealing portion of the first seal element is formed as comprising a bead portion, the bead portion being compressible intermediate the interfacing surfaces to effect the seal therebetween.

7. The gasket of claim 1 wherein the wedging portion of the first seal element is configured as tapering radially inwardly from the outboard side to the inboard side.

8. The gasket of claim 7 wherein the wedging portion outboard side is axially thicker than the wedging portion inboard side.

9. The gasket of claim 1 further comprising a generally annular second seal element supported on the retainer to extend radially beyond the other one of the one of the retainer inner or outer perimeters, the second seal element extending along at least a portion of the other one of the retainer inner or outer perimeter and being configured in a free state to be compressible axially intermediate the interfacing surfaces into an energized state effecting a seal therebetween.

10. The gasket of claim 9 wherein the first and the second seal element each is formed, independently, of an elastomeric material.

11. The gasket of claim 1 wherein the first seal element is formed of an elastomeric material.

12. The gasket of claim 1 wherein:
at least one of the retainer first and second radial surfaces has a mounting groove formed therein intermediate the retainer inner and outer perimeters, the mounting groove extending radially along at least a portion of the retainer; and
the gasket further comprises a third seal element received in the mounting groove to extend therein radially along at least a portion of the retainer, the third seal element being configured in a free state to be compressible axially intermediate the interfacing surfaces into an energized state effecting a seal therebetween.

13. The gasket of claim 1 wherein:
each of the interfacing surfaces further includes one or more bores in registration with a corresponding one of the bores of the other interface surface for defining a hole configured to receive an associated fastener member;
the retainer further comprises one or more apertures formed axially through the first and the second radial surface intermediate the retainer inner and outer perimeters, each of the apertures being configured for generally coaxial registration with a corresponding one of the fastener member holes;
the retainer first radial surface has a first mounting groove formed therein intermediate the retainer inner perimeter and the apertures;
the retainer second radial surface has a second mounting groove formed therein intermediate the retainer outer perimeter and the apertures; and
the gasket further comprises:
a third seal element received in the first mounting groove to extend therein radially along at least a portion of the retainer, the third seal element being configured in a free state to be compressible axially in the first groove by one of the interfacing surfaces into an energized state effecting a seal therewith; and
a fourth seal element received in the second mounting groove to extend therein radially along at least a portion of the retainer, the fourth seal element being configured in a free state to be compressible axially in the second groove by the other one of the interfacing surfaces into an energized state effecting a seal therewith.

14. A sealing assembly comprising:
a first and a second interfacing surface, one of the interfacing surfaces having an edge and a void space defined therealong; and
a gasket interposable between the interfacing surfaces, the gasket comprising:
a retainer having an inner perimeter and an outer perimeter, and having opposing first and second radial faces each extending in a radial direction intermediate the inner and outer perimeter; and
a generally annular first seal element supported on the retainer to extend radially beyond one of the retainer inner or outer perimeter, the first seal element having an inboard sealing portion extending along at least a portion of the one of the retainer inner or outer perimeter and an outboard wedging portion extending along at least a portion of the sealing portion and having an inboard side disposed adjacent the sealing portion and an outboard side, the sealing portion being configured in a free state to be compressible in an axial direction generally normal to the radial direction intermediate the interfacing surfaces into an energized state effecting a seal therebetween, and the outboard side of the wedging portion being configured in a free state to extend into the area of the void space along the edge of the one of the interfacing surface and to be wedged against the other one of the interfacing surfaces and thereby made to occupy at least a portion of the void space.

15. The sealing assembly of claim 14 wherein the void space is defined by a radius or chamfer of the one of the interfacing surfaces, the radius or chamfer extending between a radial terminus of the one of the surfaces and the edge, the outboard side of the gasket wedging portion being configured in a free state to extend beyond the radial terminus of the one of the surfaces.

16. The sealing assembly of claim 14 wherein:
the gasket retainer inner and outer perimeter define a closed geometry; and
the gasket first seal element extends radially beyond the retainer inner perimeter and defines an inner periphery of the gasket.

17. The sealing assembly of claim 14 wherein the gasket first seal element extends generally continuously along substantially the entirety of the one of the retainer inner or outer perimeters.

18. The sealing assembly of claim 14 wherein the gasket retainer has an inner axial surface extending axially intermediate the first and second radial faces which inner axial surface defines the inner perimeter of the retainer, and an outer axial surface extending intermediate the first and second radial faces which outer axial surface defines the outer perimeter of the retainer.

19. The sealing assembly of claim 14 wherein the sealing portion of the gasket first seal element is formed as comprising a bead portion, the bead portion being compressible intermediate the interfacing surfaces to effect the seal therebetween.

20. The sealing assembly of claim 14 wherein the wedging portion of the gasket first seal element is configured as tapering radially inwardly from the outboard side to the inboard side.

21. The sealing assembly of claim 20 wherein the wedging portion outboard side is axially thicker than the wedging portion inboard side.

22. The sealing assembly of claim 14 further wherein the gasket further comprises a generally annular second seal element supported on the retainer to extend radially beyond the other one of the one of the retainer inner or outer perimeters, the second seal element extending along at least a portion of the other one of the retainer inner or outer perimeter and being configured in a free state to be compressible axially intermediate the interfacing surfaces into an energized state effecting a seal therebetween.

23. The sealing assembly of claim 22 wherein the gasket first and the second seal element each is formed, independently, of an elastomeric material.

24. The sealing assembly of claim 14 wherein the gasket first seal element is formed of an elastomeric material.

25. The sealing assembly of claim 14 wherein:
at least one of the gasket retainer first and second radial surfaces has a mounting groove formed therein intermediate the retainer inner and outer perimeters, the mounting groove extending radially along at least a portion of the retainer; and
the gasket further comprises a third seal element received in the mounting groove to extend therein radially along at least a portion of the retainer, the third seal element being configured in a free state to be compressible axially intermediate the interfacing surfaces into an energized state effecting a seal therebetween.

26. The sealing assembly of claim 14 wherein:
each of the interfacing surfaces further includes one or more bores in registration with a corresponding one of the bores of the other interface surface for defining a hole configured to receive an associated fastener member;
the retainer further comprises one or more apertures formed axially through the first and the second radial surface intermediate the retainer inner and outer perimeters, each of the apertures being configured for generally coaxial registration with a corresponding one of the fastener member holes;
the retainer first radial surface has a first mounting groove formed therein intermediate the retainer inner perimeter and the apertures;
the retainer second radial surface has a second mounting groove formed therein intermediate the retainer outer perimeter and the apertures; and
the gasket further comprises:
a third seal element received in the first mounting groove to extend therein radially along at least a portion of the retainer, the third seal element being configured in a free state to be compressible axially in the first groove by one of the interfacing surfaces into an energized state effecting a seal therewith; and
a fourth seal element received in the second mounting groove to extend therein radially along at least a portion of the retainer, the fourth seal element being configured in a free state to be compressible axially in the second groove by the other one of the interfacing surfaces into an energized state effecting a seal therewith.
